(19) United States
(12) Patent Application Publication
(10) Pub. No.: US 2017/0361765 A1
(43) Pub. Date: Dec. 21, 2017

(54) NAVIGATION SIGNALING SYSTEM AND METHOD THEREOF

(71) Applicant: EcoReco Global Corporation, Victoria (SC)

(72) Inventor: Jay SUNG, Victoria (SC)

(21) Appl. No.: 15/183,968

(22) Filed: Jun. 16, 2016

(51) Int. Cl. B60Q 1/34

(52) U.S. Cl. CPC B60Q 1/346

(57) ABSTRACT

A navigation signaling system for communicating navigation information of a personal transportation device is provided. The navigation signaling system includes a computer and a navigation system. The computer has at least one display device. The navigation system is coupled to the computer and provides a current position and a course data of the personal transportation device. The computer drives the signal display device to display a directional signal flashing in increasing frequency as a function of proximity of the current position to a turn event in the course data.

### BACKGROUND

### 1. Technical Field

The present disclosure generally relates to a navigation signaling system and method thereof for communicating navigation information of a personal transportation device; particularly, the present disclosure relates to a navigation signaling system and method thereof for communicating navigational direction and distance to a turn event along a navigation course.

### 2. Description of the Related Art

As traffic congestion and rising pollution have become a concern for society, personal mobility vehicles have steadily gained attention from consumers as a legitimate alternative transportation method since personal mobility vehicles are light, compact, and easy to navigate through traffic However, there is greater risk to injury when operating personal mobility vehicles since personal mobility vehicles are more susceptible to road conditions and users may inadvertently fall off the personal mobility vehicles due to those susceptible circumstances, especially when users are trying to read traditional electronic navigation maps while riding. Accordingly, there is a need to simplify traditional navigation systems in order to decrease information overload that may affect operators' ability to steer their personal mobility vehicles.

### SUMMARY

It is an objective of the present disclosure to provide a navigation signaling system and method thereof for communicating turn direction and distance to turn event along a navigation course.

It is another objective of the present disclosure to provide a navigation signaling system and method thereof for decreasing information display overload.

According to one aspect of the invention, a navigation signaling system for communicating navigation information of a personal transportation device is provided. The navigation signaling system includes a computer and a navigation system. The computer has at least one display device. The navigation system is coupled to the computer and provides a current position and a course data of the personal transportation device. The computer drives the signal display device to display a directional signal flashing in increasing frequency as a function of proximity of the current position to a turn event in the course data.

According to another aspect of the invention, a method for guiding a user on a personal transportation device along a course route in a course data is provided. The method includes: providing, with a navigation system, a current position of the personal transportation device to a computer having at least one signal display device; generating, with the computer, a direction-signal driving signal according to the current position to a turn event in the course route; driving the at least one signal display device with the direction-signal driving signal to flash with increasing frequency as a function of proximity of the current position to the turn event.

### BRIEF DESCRIPTION OF THE DRAWINGS

FIG. 1 is a view of an embodiment of the navigation signaling system of the present invention;

FIG. 2 is an embodiment of a flowchart of the method of present invention;

FIG. 3A is an embodiment of a course route of a course data

FIG. 3B is a view of an embodiment approaching a turn event;

FIG. 4 is an embodiment of the signaling frequency as a function of distance to turn event;

FIG. 5A is an embodiment of the navigation signaling system; and

FIG. 5B is another embodiment of the navigation signaling system.

### DETAILED DESCRIPTION OF THE PREFERRED EMBODIMENT

Embodiments of the present invention provide methods and systems for supporting a navigation signaling system. In the following detailed description, references are made to the accompanying drawings that form a part hereof, and in which are shown by way of illustration specific embodiments or examples. These embodiments are only illustrative of the scope of the present invention, and should not be construed as a restriction on the present invention. Referring now the drawings, in which like numerals represent like elements through the several figures, aspects of the present invention and the exemplary operating environment will be described.

The present disclosure provides a navigation signaling system and method thereof. Preferably, the navigation signaling system and method may be applicable to motorized or non-motorized personal transportation devices or vehicles, including (but not limited to) two to four wheeled personal vehicles such as bikes, e-bikes, segway, trikes, scooters, skateboards, rocket-skates, motorcycles, All-Terrain vehicles (ATV), and other related personal transportation devices.

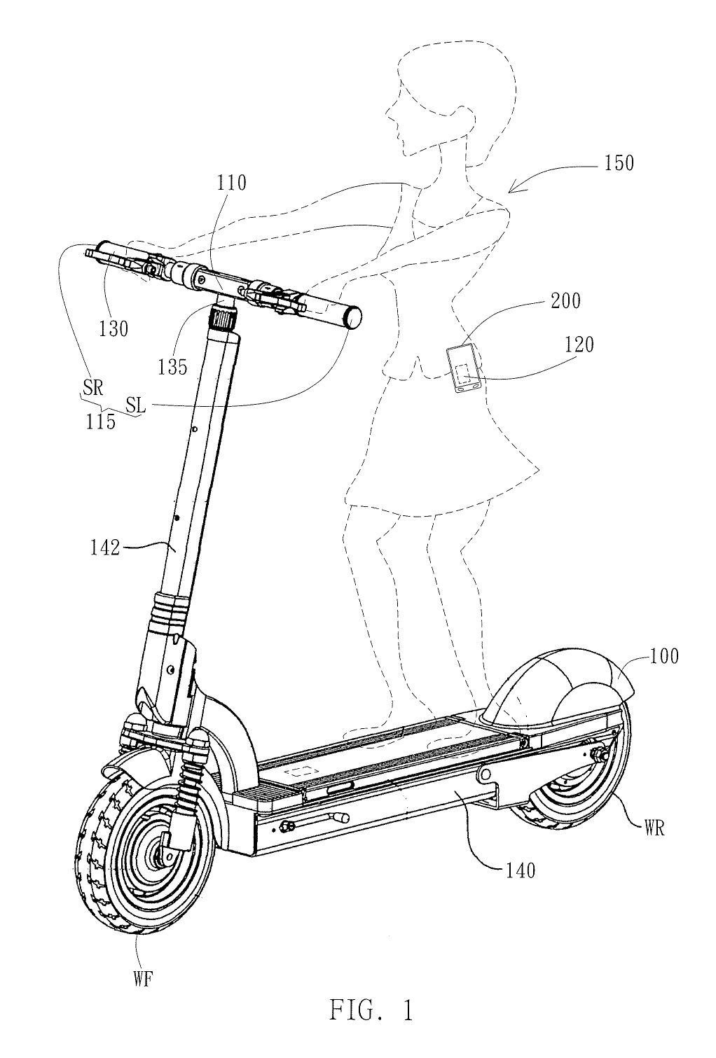

FIG. 1 is an embodiment of the navigation signaling system of the present invention for communicating navigation information. The navigation signaling system includes a computer 110 and a navigation system 120, wherein the navigation system 120 is coupled to the computer 110 on a personal transportation device or vehicle 100.

In the present embodiment, the personal vehicle 100 is shown as a scooter; however, the personal vehicle 100 is not restricted or limited to being a scooter. In other different embodiments, the personal vehicle 100 may be a motorized or non-motorized transportation device. For instance, the personal vehicle 100 may be a motorcycle, bicycle, motorized longboards or skateboards, or any other related personal or compact transportation vehicle.

As illustrated in FIG. 1, the computer 110 and the navigation system 120 are disposed on the personal vehicle 100. For instance, the computer 110 may be disposed directly on the personal vehicle 100, while the navigation system 120 may be carried by an user 150 on the personal vehicle 100. In the present embodiment, the computer 110 and the navigation system 120 are disposed in approximately the same area on the personal vehicle 100 in order to decrease the amount of wiring connections needed between them, which in turn allows weight savings to be accomplished. In one embodiment, the computer 110 and the navigation system 120 may be separate units of hardware that are connected through wire or wireless means, such as through Bluetooth technology or WiFi communication; however, in other different embodiments, the computer 110 and the navigation system 120 are formed together in the same unit hardware.

As illustrated in FIG. 1, in the present embodiment, the computer 110 and/or the navigation system 120 may be disposed on the handlebar 130 of the personal vehicle 100. In the present embodiment, the computer 110 may refer to a hardware that includes a data processor, such as a central processing unit. The computer 110 has at least one signal display device, wherein the signal display device may be any form of turn signal indicator, such as a display that indicates a turn signal, or actual turn signal indicator lights that light up to signal a turn status. In the present embodiment, as illustrated in FIG. 1, the signal display device is composed of a left-turn indicator SL and a right-turn indicator SR, wherein these two indicators are indicator lights that are coupled to the computer 110. The computer 110 can drive or control these two indicators to flash or light up.

In the present embodiment, the navigation system 120 may refer to a hardware that can determine the location of the personal vehicle 100 in relation to a course data, wherein the course data represents information pertaining to the road conditions between the current position of the personal vehicle 100 and a target destination or position. For instance, if a user would like to travel from a point A to a point E, the course data would be the road map encompassing point A to point E that includes a course route from point A to point E.

In the present embodiment, the navigation system 120 may have global positioning system (GPS) capabilities to retrieve the current position of the personal vehicle 100 to provide to the computer 110. In other different embodiments, the navigation system 120 may generate the current position based on WiFi positioning system (WPS) to provide to the computer 110. In addition, in one embodiment, the navigation system 120 may not physically be connected to the computer 110 or the personal vehicle 100. For instance, the navigation system 120 may be included within a mobile cellphone 200 carried by a user 150.

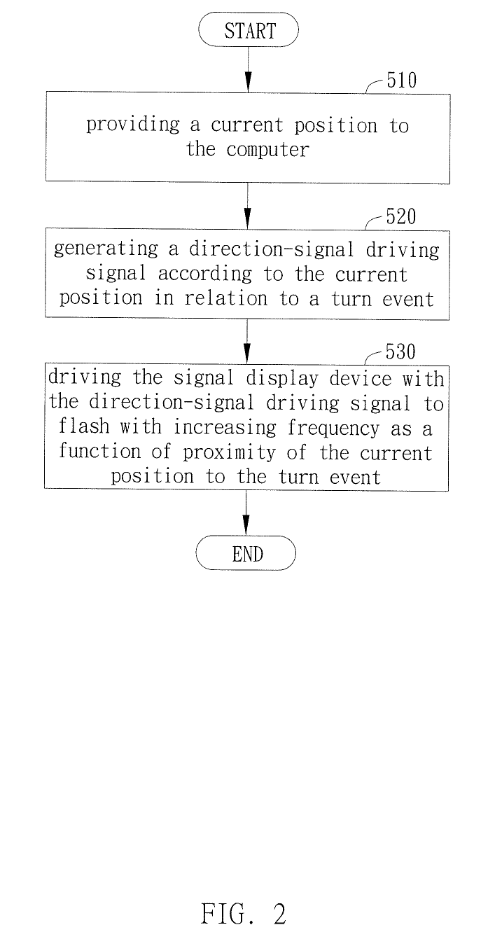

FIG. 2 illustrates a flowchart of an embodiment of the method of communicating navigation events. As shown in FIG. 2, the method includes steps 510 to 530, of which will be described as following:

Step 510 includes providing the current position of the personal vehicle 100 to the computer 110. In the present embodiment, the navigation system 120 will first retrieve the current position of the personal vehicle 100 via GPS or WPS. In one embodiment, the navigation system 120 may be realized through a handheld device, such as the mobile cellphone 200 illustrated in FIG. 1. However, in other different embodiments, the handheld device may be a fitness tracker or fitness watch having GPS or WPS capabilities.

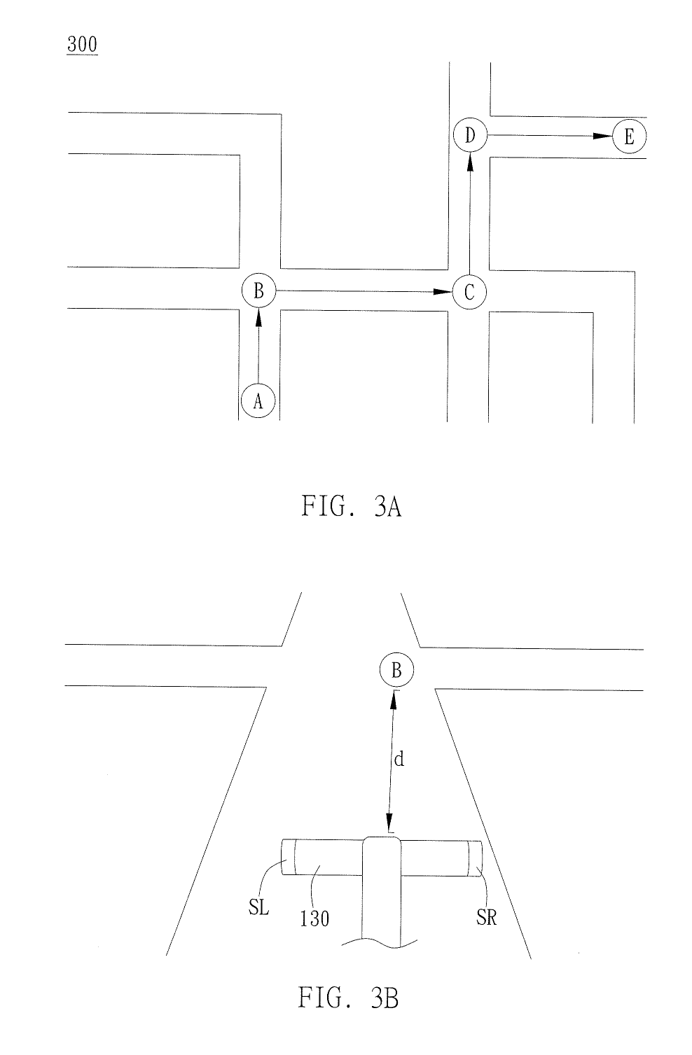

In one embodiment, the user 150 may enter a target position or destination that the user 150 would like to travel to into the navigation system 120 through the handheld device, wherein the navigation system 120 will then generate a course data that includes a road map and course route that shows the current position to the target position. For instance, as illustrated in FIG. 3A, the course data 300 may include a road map with the navigation course route from positions A to position E, wherein position A is the current position of the personal vehicle 100 that the user 150 is riding or standing on, and position E is the target position or destination that the user 150 would like to reach.

Step 520 includes generating a direction-signal driving signal according to the current position in relation to a turn event in the course route. FIG. 3B is an embodiment of the user 150 approaching an intersection in the road on the personal vehicle 100. As illustrated in FIGS. 3A and 3B, when the user 150 approaches an intersection where a turn event occurs, for instance turn event B, the navigation system 120 will constantly update the computer 110 on the current position A of the user 150 in relation to the turn event B. In other words, by determining the relationship between the current position A in relation to the turn event B, the computer 110 can determine the distance d to the turn event B in real time. In the present embodiment, when the distance d to the turn event reaches a certain distance, for instance 14 meters, the computer 110 will start to generate the direction-signal driving signal.

Step 530 includes driving the signal display device 115 with the direction-signal driving signal. In the present embodiment, the direction-signal driving signal is an electronic signal generated by the computer 110 to drive the signal display device 115. For example, when the user 150 approaches the intersection of the event B and reaches the exemplary distance of 14 meters to the turn event B, based on the course data 300 and the course route of FIG. 3A, the computer 110 can generate the direction-signal driving signal to drive the right-turn signal (indicator) SR of the signal display device 115 of FIGS. 1 and 3B to light up. In this manner, when the right-turn signal SR turns on, the user 150 would intuitively understand that a right turn maneuver is approaching.

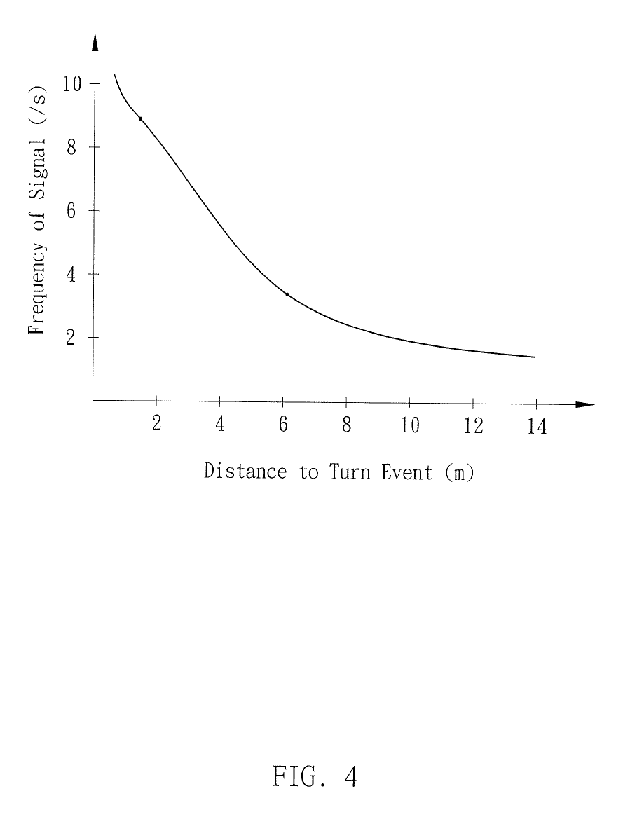

FIG. 4 is an embodiment of the frequency of signal flashes as a function of distance or proximity to the turn event. As shown in FIGS. 3B and 4, when the user 150 approaches the turn event B and reaches an exemplarily distance d of 14 meters to the turn event B, the computer 110 will drive the right-turn signal (indicator) SR of the signal display device 115 with the direction-signal driving signal to flash or light up at a frequency of twice per second. As the distance d is shortened as the user 150 approaches closer to the turn event B, the computer 110 will modulate or adjust the direction-signal driving signal to drive the signal display device 115 to flash or light up at an increasing rate. In other words, the closer the user 150 approaches the event B on the personal vehicle 100, the shorter the distance d will be and the frequency of the right-turn signal SR lighting up or flashing will increase. In this manner, the user 150 would be able to intuitively judge the distance to the turn event through the increasing frequency of flashing by the signal display device 115. In addition, in one embodiment, when the user 150 has actually reached the turn event B, the right-turn signal SR would be fully turned on and stop flashing. This would indicate to the user 150 that the user 150 has reached the turn event B position and should start to execute the turn maneuver. In should be noted that the numerical figures used for the frequency of flashes and the distance d are only given to exemplarily describe embodiments of the present invention. The rate and duration at which the turn-signals increasingly flash as the personal vehicle 100 approaches a turn event can be adjusted.

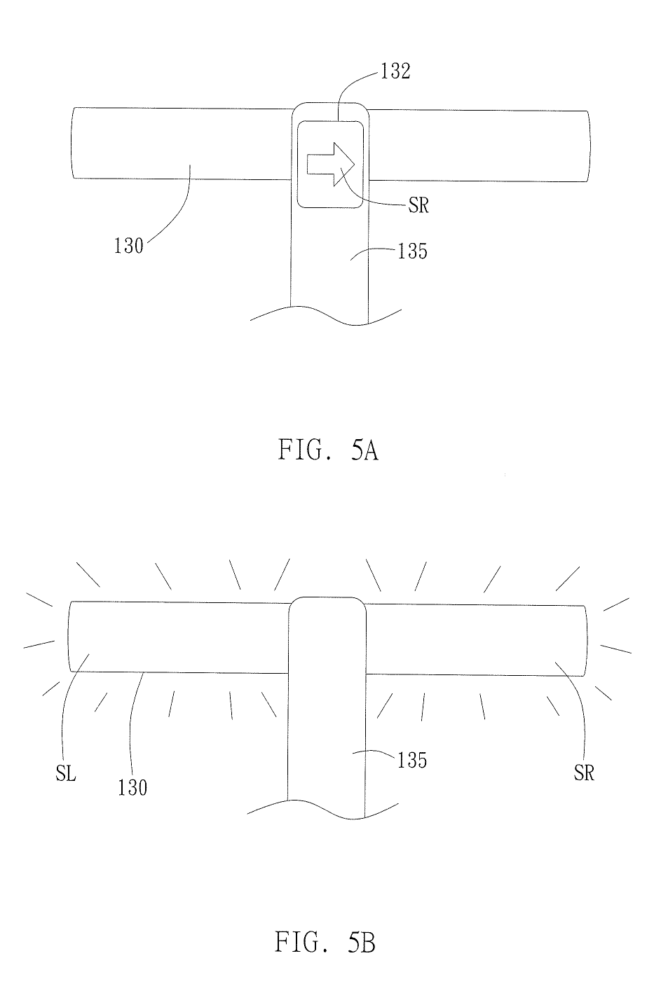

FIGS. 5A and 5B are embodiments of the signal display device 115. As illustrated in FIG. 5A, the signal display device 115 may be installed on a stem 135 connected to the handlebar 130. The signal display device 115 may further include a display or screen 132, wherein directional signals such as the right-turn signal SR may be displayed. For instance, in the above example where the personal vehicle is approaching the turn event B, the computer 110 can drive the signal display device 115 to display or start flashing the right-turn signal SR on the display 132.

FIG. 5B is another embodiment of FIG. 5A, wherein the signal display device 115 is directly integrated into the handlebar 130, wherein the handlebar 130 can be formed from a transparent material that is conducive to light transmission, and the light source of the left-turn signal SL and the right-turn signal SR are integrated in the stem 135 and lights into the handlebar 130. In this manner, when the computer 110 drives the signal display device 115, the signal display device 115 can light up the entire left hand side or right hand side of the handlebar 130.

In one embodiment, the computer 110 and the signal display device 115 may be detachable from the personal transportation device or vehicle 100. In other words, the navigation signaling system 100 can also be sold in stores as an after-market accessory for any non-electric transportation vehicles. For instance, the navigation signaling system 100 may be purchased off the shelf in stores and attached to any personal transportation device, such as having the right-turn signal SR and left-turn signal SL previously mentioned installed on a skateboard and having the navigation signaling system 100 indicating to users of upcoming turn events with the right-turn signal SR or left-turn signal SL.

Although the embodiments of the present invention have been described herein, the above description is merely illustrative. Further modification of the invention herein disclosed will occur to those skilled in the respective arts and all such modifications are deemed to be within the scope of the invention as defined by the appended claims.

1. A navigation signaling system for communicating navigation information of a personal transportation device, comprising:
a computer having at least two signal display devices, the at least two signal display devices including a right-turn signal display device and a left-turn signal display device;
a navigation system coupled to the computer for providing a current position and a course data of the personal transportation device;
wherein the computer drives one of the right-turn and left-turn signal display devices to display a directional signal flashing in increasing frequency as a function of proximity of the current position to a right or left turn event in the course data.

2. The navigation signaling system of claim 1, wherein the course data includes a course route between the current position and a target position.

3. The navigation signaling system of claim 2, wherein the course route includes one or more turn events between the current position and the target position.

4. The navigation signaling system of claim 1, wherein the personal transportation device includes a front and a back wheel, and a deck between the front wheel and the back wheel.

5. The navigation signaling system of claim 1, wherein the directional signal includes at least one left-turn signal and one right-turn signal.

6. The navigation signaling system of claim 1, wherein the signal display device includes a display, and the computer drives the display to display the directional signal.

7. The navigation signaling system of claim 1, wherein the navigation system has global positioning system (GPS) capability, the navigation system retrieves the current position using the GPS capability and provides the current position to the computer.

8. The navigation signaling system of claim 1, wherein the navigation system has internet capability, the navigation system generates the current position based on WiFi positioning system (WPS).

9. The navigation signaling system of claim 1, wherein the personal transportation device has a handlebar, the signal display device is disposed on the handlebar.

10. The navigation signaling system of claim 9, wherein the signal display device includes a left-turn light and a right-turn light, the left-turn signal display device is disposed on a left end of the handlebar, and the right-turn signal display device is disposed on a right end of the handlebar.

11. A method for guiding a user on a personal transportation device along a course route in a course data, comprising:
providing, with a navigation system, a current position of the personal transportation device to a computer having at least two signal display devices, the at least two signal display devices including a right-turn signal display device and a left-turn signal display device;
generating, with the computer, a direction-signal driving signal according to the current position to a right or left turn event in the course route;
driving one of the right-turn and left-turn signal display devices with the direction-signal driving signal to flash with increasing frequency as a function of proximity of the current position to the right or left turn event.

12. The method of claim 11, further comprising:
retrieving, with the navigation system, the course data and the current position via global positioning system or WiFi positioning system.

13. The method of claim 11, further comprising:
determining, with the computer, a distance between the current position to the turn event in the course route; and
generating, according to the distance, the direction-signal driving signal.

14. The method of claim 13, further comprising:
increasing the frequency of turning on the signal display device by modulating the direction-signal driving signal based on the distance.

15. The method of claim 14, further comprising:
adjusting the direction-signal driving signal to drive the signal display device to fully turn on when the distance to the turn event is substantially equal to zero.

16. A navigation signaling system for communicating navigation information, comprising:
a computer having at least one signal display device, the at least one signal display device displaying a directional arrow indicating a turn direction;
a navigation system coupled to the computer for providing a current position and a course data;
wherein the computer drives the signal display device to display the directional arrow flashing in increasing frequency as a function of proximity of the current position to a turn event in the course data.
